(19) United States
(12) Patent Application Publication
(10) Pub. No.: US 2002/0099983 A1
(43) Pub. Date: Jul. 25, 2002

(54) Method of reporting errors occurring in the execution of a program in an electronic terminal

(76) Inventor: Alexandre Henon, Teloche (FR)

Correspondence Address: Philips Electronics North Amercia Corporation, 580 White Plains Road, Tarrytown, NY, 10591, US

(21) Appl. No.: 10/052,385

(22) Filed: Jan. 18, 2002

(30) Foreign Application Priority Data
Jan. 23, 2001 (FR) 0100886

(51) Int. Cl. G06F 11/32

(52) U.S. Cl. 714/57

(57) ABSTRACT

The invention proposes a method of reporting errors occurring in the execution of a program in an electronic terminal. When an error occurs during the execution of a program, a data item relating to this error is processed automatically and stored in an error memory of the terminal. The contents of the error memory are transmitted to a remote apparatus (for example, to a server belonging to the manufacturer of the terminal) either periodically, or when the error memory is full, or upon request by the server. This transmission can be advantageously effected by means of an electronic message of the Internet, WAP or I-MODE type.

Applications: any electronic terminal equipped with means of telecommunication suitable for transmitting the contents of a memory.

### FIELD OF THE INVENTION

The invention relates to an electronic terminal comprising at least a program memory for storing at least a program, and at least a processor intended to execute said program. It also relates to a telecommunication system comprising a terminal of this kind.

The invention also relates to a method of reporting errors, which occur in the execution of programs in an electronic terminal of this kind.

Finally, the invention relates to a method of retrieving errors, which may occur during the execution of at least a program in at least an electronic terminal.

The invention is advantageously applied in the field of consumer electronics. The invention applies, for example, to terminals for mobile telephony.

### BACKGROUND ART RELATING TO THE INVENTION

International patent application WO 98/38820 describes a method of downloading a computer program to an apparatus for mobile telephony. This method is utilized for adding new functionalities to the apparatus, or for correcting bugs which may exist in its programs. A download of this kind is carried out by means of SMS (Short Message Service).

The method described in this document therefore allows the programs stored in a memory of an electronic terminal to be corrected remotely.

### SUMMARY OF THE INVENTION

One object of the invention is to present a method which allows a terminal to report the errors occurring during the execution of a program.

This object is achieved with a terminal according to the invention which comprises at least a program memory for storing at least a program, at least a processor intended to execute said program, means for automatically generating at least a data item relating to an error in executing said program, an error memory for storing said data item, and transmission means for transmitting the contents of said error memory.

Another object of the invention is to propose a method which allows the errors to be retrieved that may occur in an electronic terminal during the execution of a program.

This object is achieved with a method of retrieving errors according to the invention which comprises:

equipping said terminal with means for automatically generating at least a data item relating to at least an error in the execution of a program, an error memory for storing said data item, and transmission means for transmitting the contents of said error memory,

providing at least a central electronic apparatus intended to receive the contents of the memory for errors that may be transmitted by said terminal.

Said data item advantageously comprises an indication of the position, in the said program, at which the error occurred, and possibly an indication of the location of the apparatus when the error occurred, and possibly an indication of the time at which the error occurred.

The contents of the error memory are advantageously transmitted in the form of a radio message, or in the form of electronic mail. They are transmitted periodically for example, and/or when the error memory is full, and/or upon request.

The invention allows the manufacturer to be aware of malfunctions of the products that have been sold, without the need for customers to bring their terminal back for this purpose. Thanks to the invention, the manufacturer has a much greater amount of data available which allows to:

be aware in an exhaustive manner of all the errors that occur,

correct them much more quickly,

compare the behaviour of various terminals and various program versions,

obtain statistical data relating to the errors which occur during the execution of programs,

not depend exclusively on the information that the operators are likely to supply to it.

The manufacturer's quality of service is greatly improved by this without any additional effort being required of the customer.

### BRIEF DESCRIPTION OF THE DRAWINGS

These and other aspects of the invention are apparent from and will be elucidated, by way of non-limiting example, with reference to the embodiment(s) described hereinafter.

In the drawings:

FIG. 1 shows a diagram of an example of a transmission system according to the invention,

FIG. 2 shows a diagram of an example of a terminal for mobile telephony according to the invention,

FIG. 3 shows a block diagram which describes the various steps of a method according to the invention for reporting errors which occur during the execution of a program.

### DESCRIPTION OF A PREFERRED EMBODIMENT OF THE INVENTION

In the following of this description, the invention will be described in the context of a network for mobile telephony. This is not limitative. The invention is applicable to other types of terminal utilising other means of communication. For example, it is applicable to set-top boxes in distribution networks employing cable, satellites or radio waves.

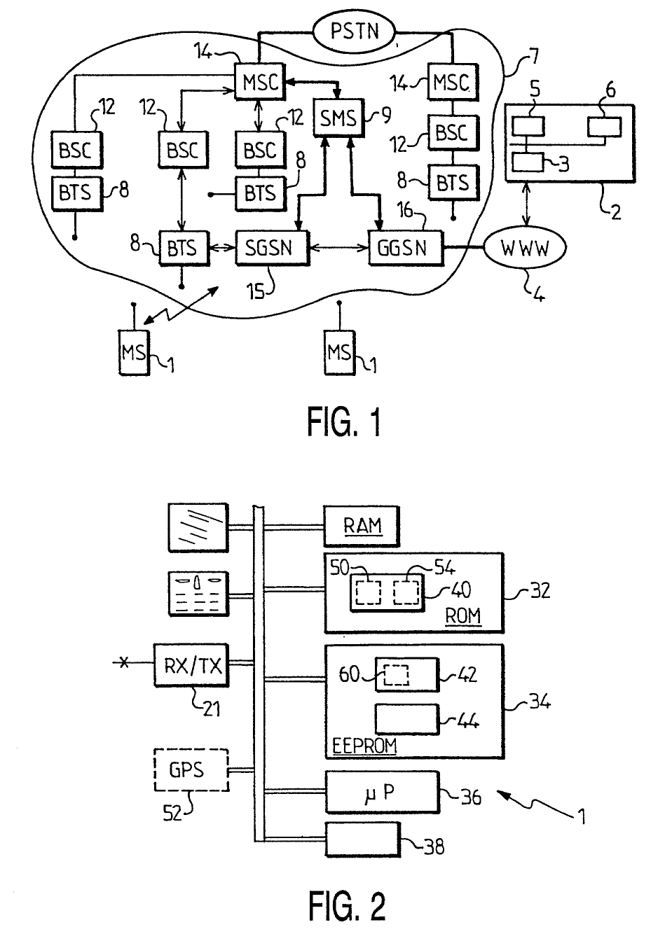

FIG. 1 shows an example of a telecommunications system according to the invention. The system in FIG. 1 comprises:

mobile terminals 1,

a central electronic apparatus 2 which in this example is a data processing server equipped with means of access 3 to the Internet 4, means of storing data 5, and data for processing means 6,

a mobile telecommunications network 7

The mobile telecommunications network 7 conventionally comprises base stations 8 which may communicate by radio waves with the mobile terminals 1, the base station controllers 12 and mobile switching centres 14. The mobile switching centres 14 are interconnected between themselves by means of a public switched telephone network (PSTN).

One or more messaging centres 9 may be connected to one or more mobile switching centres 14. These messaging centres 9 are intended to send or receive short radio messages (currently referred to as SMS from the English Short Message Service) intended for or originating from the mobile terminals 1.

In addition, advantageously, the mobile telecommunications network 7 contains GPRS nodes. By way of example, service nodes 15 (currently referred to as SGSN from the English Serving GPRS Support Node) are connected to base stations 8, on the one hand, and the messaging centres 9, on the other hand. Similarly, the gateway nodes 16 (currently referred to as GGSN from the English Gateway GPRS Support Node) are connected to the messaging centres 9, on the one hand, and service nodes 15, on the other hand. The gateway nodes 16 are advantageously equipped with an access to the Internet 4.

FIG. 2 shows an example of a mobile terminal 1. This mobile terminal 1 comprises means of radio transmission/reception 21, a microprocessor assembly 22, a screen 23 and a keyboard 24. The microprocessor assembly 22 comprises in particular a read/write memory 30, a read-only memory 32, a reprogrammable non-volatile memory 34 (of the EEPROM type, for example), a microprocessor 36, and a clock 38. The read-only memory 32 contains a first program memory 40, and the non-volatile memory 34 contains a second program memory 42. The operating programs for the terminal are stored in the first or the second program memory according to whether they are likely to be modified or not. The non-volatile memory 34 also comprises an error memory 44.

The mobile terminals 1 advantageously comprise means for sending electronic messages of the Internet, WAP or I-MODE type. These means are in the form of one or more specific programs 50 stored in one of the program memories 40 or 42.

In addition, a mobile terminal 1 advantageously contains means for determining its location. These means can be based on the GPS technology (Global Positioning System), or on network-type technologies which use the infrastructure of the mobile telecommunications network for determining the position of the terminal. Details on locating technologies for mobile telecommunication network terminals can be found in the article “An overview of the challenges and progress in meeting the E-911 requirement for location service” by Jeffrey H. Reed, Kevin J. Krizman, Brian D. Woerner and Theodore S. Rappaport published in the journal IEEE Communication Magazine dated April 1998. Where the GPS technology is utilised, the means for determining the location of the terminal are in the form of a dedicated microprocessor assembly (in FIG. 1, a dedicated microprocessor assembly 50 is shown in dotted lines). If a network-type technology is utilised, the means for determining the location of the terminal are in the form of specific location calculating programs 54 which are stored in one of the program memories 40 or 42.

In a conventional manner, each program is organized in modules which comprise one or more files, the latter containing one or more functions. A function comprises a series of instructions. It may happen that the behaviour of a function is not in accordance with what is provided in that series of instructions. In such a case, an error occurs the execution of the program. To illustrate this error phenomenon, three examples of errors that may occur during the execution of a program will be given:

1) the program is waiting for reception of a predetermined message, and it receives another message;

2) the program has made a request to obtain a memory allocation and there is no more memory available;

3) the dialogue with the microprocessor 36 is not carried out correctly (due to bad initialisation of the microprocessor, for example).

In general, there is an error in the execution of a program when the data received by the program is not in accordance with the data expected by the program.

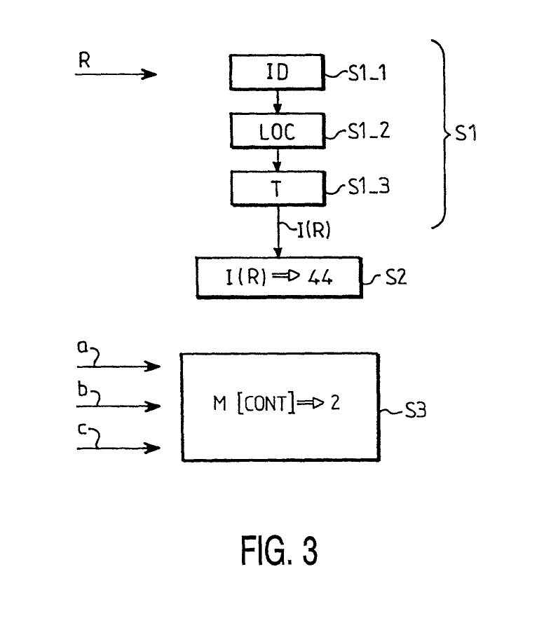

As shown in FIG. 3, when an error R occurs, a specific program 60 (stored in the program memory 42) is activated to determine a data item I(R) relating to the said error (step S1), and to store said data item in the error memory 44 (step S2). The step S1 comprises, for example:

recovering an identifier ID which indicates the module, the file and the function in which the error occurred (step S1-1),

determining the location LOC of the terminal (step S1-2),

reading the time T indicated by the clock 38 (step S1-3).

The data item relating to the error comprises advantageously the identifier ID, the location LOC and the time T.

In another embodiment, instead of recovering the identifier ID, the address of the instruction at which the program was interrupted can be recovered.

In accordance with the program 60, the contents CONT of the memory 44 are transmitted to the server 2, in step S3, in the following cases:

a: the error memory 44 is full,

b: the terminal receives a request originating from the server 2 asking it to transmit the contents of its error memory 44,

c: the transmission is effected periodically, and the time indicated by the clock 38 corresponds to a transmission point.

This transmission is advantageously effected by sending an electronic message M[CONT] of the Internet type which will be routed across the mobile telephone network 7 to a GPRS gateway node equipped with access to the Internet, then across the Internet 4 to the server 2.

In another embodiment, the contents of the error memory are transmitted in one or more short radio messages of the SMS type. In this case, the short radio message or messages pass over the mobile telecommunication network 7 to a messaging centre 9 where they are transformed into an electronic message of the Internet, WAP or I-MODE type. The electronic message obtained in this way subsequently passes over the Internet 4 (via a GPRS gateway node, for example) to the server 2 which is the destination.

The invention is not limited to the embodiments described by way of example.

In particular, it is not limited to the sending of electronic messages of the Internet type via a network of the GPRS type. It is applicable to other types of network, and to other transport means and transport protocols (transport of the WAP type in circuit mode via a network of the GSM type, for example, or transport of the I-MODE type in the packet mode via a network of the GPRS or UMTS type).

The invention is also applicable in fields other than that of mobile telephony. In general, the invention applies to all types of electronic terminals equipped with telecommunication means suitable for transmitting the contents of an error memory according to the invention.

Finally, the data item relating to the execution error can comprise indications other than those quoted by way of example.

1. An electronic terminal (1) comprising at least one program memory (40, 42) for storing at least a program, at least a processor (36) intended to execute said program, means (60; S1) for automatically generating at least a data item (I(R)) relating to an error in executing said program (R), an error memory (44) for storing (60; S2) said data item, and means of transmission (21, 50) for transmitting the contents of said error memory (60; S3).

2. An electronic terminal as claimed in claim 1, characterised in that the contents of the error memory are transmitted with a view to their utilisation by the manufacturer of said terminal.

3. An electronic terminal as claimed in claim 1, characterised in that said data item comprises an indication (ID) of a position in said program at which the execution error occured.

4. An electronic terminal as claimed in claim 1, characterised in that it comprises means for determining its location (52, 54), and in that said data item comprises an indication (LOC) of the location of the apparatus when the error in executing said program occurred.

5. An electronic terminal as claimed in claim 1, characterised in that it comprises a clock (38) giving an indication of the time, and in that said data item comprises an indication of the time (T) at which the error in executing said program occurred.

6. An electronic terminal as claimed in claim 1, characterised in that the contents of the error memory are transmitted in the form of short radio messages (SMS).

7. An electronic terminal as claimed in claim 1, characterised in that the contents of the error memory are transmitted in the form of electronic mail.

8. An electronic terminal as claimed in claim 1, characterised in that the contents of the error memory are transmitted when said error memory is full (a).

9. An electronic terminal as claimed in claim 1, characterised in that the contents of the error memory are transmitted periodically (c).

10. An electronic terminal as claimed in claim 1, characterised in that the contents of the error memory are transmitted upon request (b).

11. A telecommunication system comprising at least an electronic terminal (1) as claimed in claim 1, and at least a central electronic apparatus (2) intended to receive the contents of the error memory (44) transmitted by said terminal.

12. A method of reporting errors (R) occurring in the execution of programs in an electronic terminal (1), characterised in that it comprises automatically generating at least a data item (I(R)) relating to at least an error (R) occurring during the execution of a program, storing said data item in an error memory (44) of said terminal (1), and transmitting the contents of the error memory.

13. A method of retrieving errors (R) likely to occur during the execution of at least a program in at least an electronic terminal (1), characterised in that it comprises:
equipping said terminal (1) with means (60; S1) for automatically generating at least a data item relating to at least an error in the execution of a program, an error memory (44) for storing said data item (60; S2), and means of transmission (21, 50) for transmitting the contents of said error memory (60; S3),
providing at least a central electronic apparatus (2) intended to receive the contents of the memory for errors likely to be transmitted by said terminal.
